(19) United States
(12) Patent Application Publication
(10) Pub. No.: US 2024/0296748 A1
(43) Pub. Date: Sep. 5, 2024

(54) SYSTEM AND METHOD FOR LANGUAGE SKILL DEVELOPMENT USING A VIRTUAL REALITY ENVIRONMENT

(71) Applicant: Pearson Education, Inc., Bloomington, MN (US)

(72) Inventors: Ilya GOGIN, Homestead, FL (US); Sion REILLY, London (GB); Alexandru ILIESCU, Brasov (RO); Bohdan Ruzycky, Ontario (CA)

(21) Appl. No.: 18/593,528

(22) Filed: Mar. 1, 2024

Related U.S. Application Data
(60) Provisional application No. 63/449,601, filed on Mar. 2, 2023.
(60) Provisional application No. 63/548,524, filed on Nov. 14, 2023.

(51) Int. Cl. G09B 5/06; G06F 40/40

(52) U.S. Cl. CPC G09B 5/065; G06F 40/40

(57) ABSTRACT

Systems and methods for bidirectional communication in a virtual reality environment are disclosed. The systems and methods include: generating the virtual reality environment for a first user; receiving a station selection user input to select a first language learning station; in response to the station selection user input, providing, via a graphic in the virtual reality environment, a first avatar in the first language learning station; receiving a communication from the first user in a target spoken language; providing the communication to a first artificial intelligence model; receiving, from the first artificial intelligence model, a response to the communication in the target spoken language; outputting, via the first avatar, the response in the target spoken language; and providing, via the graphic in the virtual reality environment, language assistance corresponding to the response in a natural spoken language of the first user.

### CROSS-REFERENCE TO RELATED APPLICATIONS

This application claims priority to U.S. Provisional Application No. 63/449,601, titled SYSTEM AND METHOD FOR ARTIFICIAL INTELLIGENCE-BASED LANGUAGE SKILL ASSESSMENT AND DEVELOPMENT, filed on Mar. 2, 2023, and to U.S. Provisional Application No. 63/548,524, titled SYSTEM AND METHOD FOR LANGUAGE SKILL DEVELOPMENT USING A VIRTUAL REALITY ENVIRONMENT, filed on Nov. 14, 2023, each of which are hereby incorporated by reference in their entireties.

### TECHNICAL FIELD

This disclosure relates to the field of systems and methods for computer-based development of language skills.

### SUMMARY

The disclosed technology relates to systems and methods for bidirectional communication in a virtual reality environment. In some examples, a method for bidirectional communication in a virtual reality environment is provided. The method includes generating, by an electronic processor, the virtual reality environment for a first user, the virtual reality environment comprising a plurality of language learning stations; receiving, by the electronic processor via a network, a station selection user input to select a first language learning station of the plurality of language learning stations; in response to the station selection user input, providing, via a graphic in the virtual reality environment, a first avatar in the first language learning station; receiving, by the electronic processor via the network, a communication from the first user in a target spoken language; providing, by the electronic processor, the communication to a first artificial intelligence model; receiving, from the first artificial intelligence model, a response to the communication in the target spoken language; outputting, via the first avatar, the response in the target spoken language; and providing, via the graphic in the virtual reality environment, language assistance corresponding to the response in a natural spoken language of the first user.

In some examples, a system for bidirectional communication in a virtual reality environment is provided. The system includes a memory, and a processor coupled with the memory, wherein the processor is configured to: generate the virtual reality environment for a first user, the virtual reality environment comprising a plurality of language learning stations; receive a station selection user input to select a first language learning station of the plurality of language learning stations; in response to the station selection user input, provide, via a graphic in the virtual reality environment, a first avatar in the first language learning station; receive a communication from the first user in a target spoken language; provide the communication to a first artificial intelligence model; receive, from the first artificial intelligence model, a response to the communication in the target spoken language; output, via the first avatar, the response in the target spoken language; and provide, via the graphic in the virtual reality environment, language assistance corresponding to the response in a natural spoken language of the first user.

The above features and advantages of the present invention will be better understood from the following detailed description taken in conjunction with the accompanying drawings.

### BRIEF DESCRIPTION OF THE DRAWINGS

FIG. 1 illustrates a system level block diagram for providing the disclosed virtual reality environment-based language skill development system architecture.

FIG. 2 illustrates a system level block diagram for providing the disclosed virtual reality environment-based language skill development system architecture, in accordance with various aspects of the techniques described in this disclosure.

FIG. 3 illustrates a system level block diagram of a content management system that facilitates the disclosed virtual reality environment-based language skill development system architecture, in accordance with various aspects of the techniques described in this disclosure.

FIG. 4 is a flowchart illustrating an example method and technique for bidirectional communication in a virtual reality environment, in accordance with various aspects of the techniques described in this disclosure.

FIG. 5 is a schematic diagram conceptually illustrating an example virtual reality environment, in accordance with various aspects of the techniques described in this disclosure.

FIG. 6 is a schematic diagram conceptually illustrating language learning stations in a language skill development virtual reality environment, in accordance with various aspects of the techniques described in this disclosure.

FIG. 7 is a schematic diagram conceptually illustrating a language café in a language skill development virtual reality environment, in accordance with various aspects of the techniques described in this disclosure.

FIG. 8 is a schematic diagram conceptually illustrating communication with an avatar in a language café of a language skill development virtual reality environment, in accordance with various aspects of the techniques described in this disclosure.

FIG. 9 is a schematic diagram conceptually illustrating virtual reality games for language learning in a language skill development virtual reality environment, in accordance with various aspects of the techniques described in this disclosure.

FIGS. 10A-B are schematic diagrams conceptually illustrating interaction with a user and an avatar in a language skill development virtual reality environment, in accordance with various aspects of the techniques described in this disclosure.

### DETAILED DESCRIPTION

The disclosed technology will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

Speaking practice in various real-life situations and access to a personal tutor have been among the least addressed needs of language learners. Previous computer-based language learning solutions have provided only very basic speaking practice that was constrained and mostly involved pre-recorded words or sentences of pronunciation. Further, the previous computer-based language learning solutions may not be able to provide real time feedback/assistance or can provide limited and preconfigured feedback, which is not suitable for different real-life situations and/or conversations with people having different characters and/or accents. Similarly, access to private language tutors is not affordable to most learners. Private language tutors are also subjective in providing feedback for limited and hypothetical real-life situations. Also, private language tutors are only available at a limited time based on the private language tutors' schedules. Further, language learners have difficulty finding other target language users to practice speaking due to limited other users' schedules and/or limited locations to meet. Thus, current computer-based language learning systems and methods are unable to provide an environment where language learners can practice speaking in various real-life situations and receive real-time feedback and assistance.

The disclosed system includes, among other things, a virtual reality environment with one or more digital avatars. The digital avatars are powered by generative artificial intelligence or large language models to create various real-life situations in the virtual reality environment with various conversational language people. The disclosed system can provide language assistance (e.g., providing translation to a natural language, possible responses in a target language and/or the natural language, real time feedback, etc.). Further, the disclosed system can import external language learning solutions in the virtual reality environment as a language learning station. For example, language learners can use various language learning services (e.g., internal language learning programs or external language learning programs) in one virtual reality environment. Thus, the disclosed system can improve user's language proficiency in an environment similar to the real world by having a conversation with one or more avatars, which speak like a human and provide feedback in real time. Also, the users of the disclosed system can experience real-world-like language learning because each avatar the user meets in the language skill development virtual reality environment is associated with an artificial intelligence (AI) model. Further, each AI model may be provided with different characteristics to indicate or result in a different character and/or personality for each avatar.

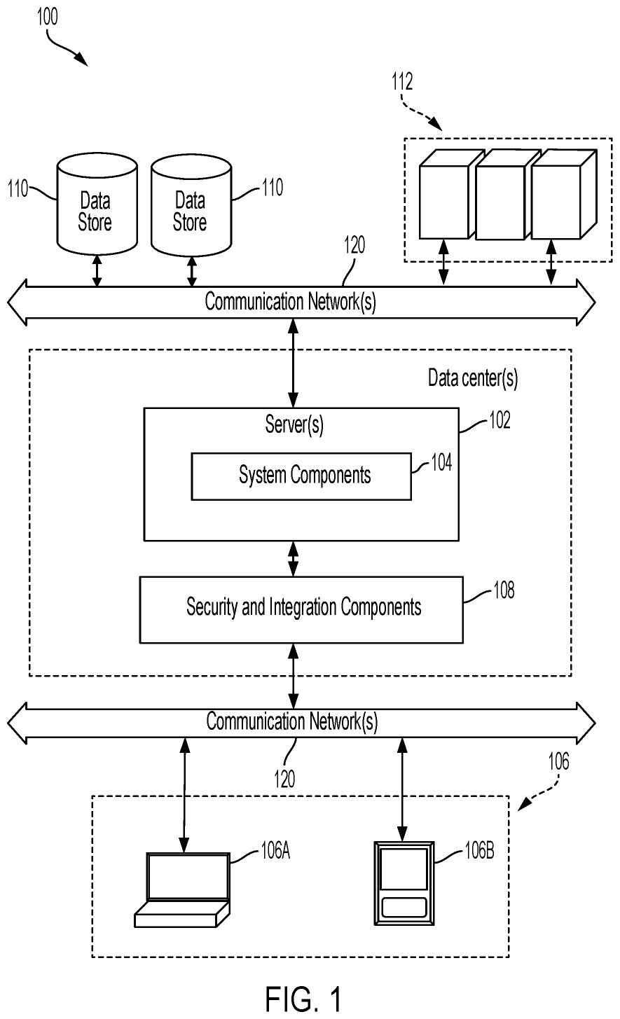

FIG. 1 illustrates a non-limiting example of a distributed computing environment 100. In some examples, the distributed computing environment 100 may include one or more server(s) 102 (e.g., data servers, computing devices, computers, etc.), one or more client computing devices 106, and other components that may implement certain embodiments and features described herein. Other devices, such as specialized sensor devices, etc., may interact with the client computing device(s) 106 and/or the server(s) 102. The server(s) 102, client computing device(s) 106, or any other devices may be configured to implement a client-server model or any other distributed computing architecture. In an illustrative and non-limiting example, the client devices 106 may include a first client device 106A and a second client device 106B. The first client device 106A may correspond to a first user in a class and the second client device 106B may correspond to a second user in the class or another class. In some examples, the client device 106 can include a virtual reality headset or any suitable computing device with a display.

In some examples, the server(s) 102, the client computing device(s) 106, and any other disclosed devices may be communicatively coupled via one or more communication network(s) 120. The communication network(s) 120 may be any type of network known in the art supporting data communications. As non-limiting examples, network 120 may be a local area network (LAN; e.g., Ethernet, Token-Ring, etc.), a wide-area network (e.g., the Internet), an infrared or wireless network, a public switched telephone networks (PSTNs), a virtual network, etc. Network 120 may use any available protocols, such as, e.g., transmission control protocol/Internet protocol (TCP/IP), systems network architecture (SNA), Internet packet exchange (IPX), Secure Sockets Layer (SSL), Transport Layer Security (TLS), Hypertext Transfer Protocol (HTTP), Secure Hypertext Transfer Protocol (HTTPS), Institute of Electrical and Electronics (IEEE) 802.11 protocol suite or other wireless protocols, and the like.

The embodiments shown in FIGS. 1 and/or 2 are respective examples of a distributed computing system and are not intended to be limiting. The subsystems and components within the server(s) 102 and the client computing device(s) 106 may be implemented in hardware, firmware, software, or combinations thereof. Various different subsystems and/or components 104 may be implemented on server 102. Users operating the client computing device(s) 106 may initiate one or more client applications to use services provided by these subsystems and components. Various different system configurations are possible in different distributed computing environments 100 and content distribution networks. Server 102 may be configured to run one or more server software applications or services, for example, web-based or cloud-based services, to support content distribution and interaction with client computing device(s) 106. Users operating client computing device(s) 106 may in turn utilize one or more client applications (e.g., virtual client applications) to interact with server 102 to utilize the services provided by these components. The client computing device(s) 106 may be configured to receive and execute client applications over the communication network(s) 120. Such client applications may be web browser-based applications and/or standalone software applications, such as mobile device applications. The client computing device(s) 106 may receive client applications from server 102 or from other application providers (e.g., public or private application stores).

As shown in FIG. 1, various security and integration components 108 may be used to manage communications over the communication network(s) 120 (e.g., a file-based integration scheme, a service-based integration scheme, etc.). In some examples, the security and integration components 108 may implement various security features for data transmission and storage, such as authenticating users or restricting access to unknown or unauthorized users. As non-limiting examples, the security and integration components 108 may include dedicated hardware, specialized networking components, and/or software (e.g., web servers, authentication servers, firewalls, routers, gateways, load balancers, etc.) within one or more data centers in one or more physical location(s) and/or operated by one or more entities, and/or may be operated within a cloud infrastructure. In various implementations, the security and integration components 108 may transmit data between the various devices in the distribution computing environment 100 (e.g., in a content distribution system or network). In some examples, the security and integration components 108 may use secure data transmission protocols and/or encryption (e.g., File Transfer Protocol (FTP), Secure File Transfer Protocol (SFTP), and/or Pretty Good Privacy (PGP) encryption) for data transfers, etc.).

In some examples, the security and integration components 108 may implement one or more web services (e.g., cross-domain and/or cross-platform web services) within the distribution computing environment 100, and may be developed for enterprise use in accordance with various web service standards (e.g., the Web Service Interoperability (WS-I) guidelines). In an example, some web services may provide secure connections, authentication, and/or confidentiality throughout the network using technologies such as SSL, TLS, HTTP, HTTPS, WS-Security standard (providing secure SOAP messages using XML encryption), etc. In some examples, the security and integration components 108 may include specialized hardware, network appliances, and the like (e.g., hardware-accelerated SSL and HTTPS), possibly installed and configured between one or more server(s) 102 and other network components. In such examples, the security and integration components 108 may thus provide secure web services, thereby allowing any external devices to communicate directly with the specialized hardware, network appliances, etc.

A distribution computing environment 100 may further include one or more data stores 110. In some examples, the one or more data stores 110 may include, and/or reside on, one or more back-end servers 112, operating in one or more data center(s) in one or more physical locations. In such examples, the one or more data stores 110 may communicate data between one or more devices, such as those connected via the one or more communication network(s) 120. In some cases, the one or more data stores 110 may reside on a non-transitory storage medium within one or more server(s) 102. In some examples, data stores 110 and back-end servers 112 may reside in a storage-area network (SAN). In addition, access to one or more data stores 110, in some examples, may be limited and/or denied based on the processes, user credentials, and/or devices attempting to interact with the one or more data stores 110.

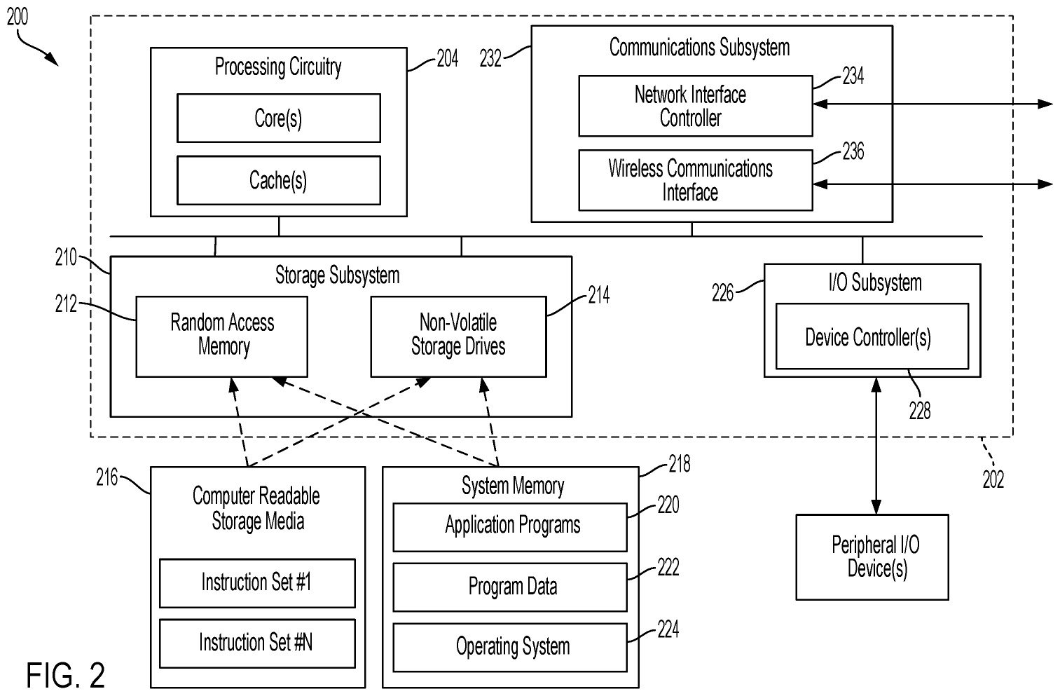

With reference now to FIG. 2, a block diagram of an example computing system 200 is shown. The computing system 200 (e.g., one or more computers) may correspond to any one or more of the computing devices or servers of the distribution computing environment 100, or any other computing devices described herein. In an example, the computing system 200 may represent an example of one or more server(s) 102 and/or of one or more server(s) 112 of the distribution computing environment 100. In another example, the computing system 200 may represent an example of the client computing device(s) 106 of the distribution computing environment 100. In some examples, the computing system 200 may represent a combination of one or more computing devices and/or servers of the distribution computing environment 100.

In some examples, the computing system 200 may include processing circuitry 204, such as one or more processing unit(s), processor(s), etc. In some examples, the processing circuitry 204 may communicate (e.g., interface) with a number of peripheral subsystems via a bus subsystem 202. These peripheral subsystems may include, for example, a storage subsystem 210, an input/output (I/O) subsystem 226, and a communications subsystem 232.

In some examples, the processing circuitry 204 may be implemented as one or more integrated circuits (e.g., a micro-processor or microcontroller). In an example, the processing circuitry 204 may control the operation of the computing system 200. The processing circuitry 204 may include single core and/or multicore (e.g., quad core, hexa-core, octo-core, ten-core, etc.) processors and processor caches. The processing circuitry 204 may execute a variety of resident software processes embodied in program code, and may maintain multiple concurrently executing programs or processes. In some examples, the processing circuitry 204 may include one or more specialized processors, (e.g., digital signal processors (DSPs), outboard, graphics application-specific, and/or other processors).

In some examples, the bus subsystem 202 provides a mechanism for intended communication between the various components and subsystems of computing system 200. Although the bus subsystem 202 is shown schematically as a single bus, alternative embodiments of the bus subsystem may utilize multiple buses. In some examples, the bus subsystem 202 may include a memory bus, memory controller, peripheral bus, and/or local bus using any of a variety of bus architectures (e.g., Industry Standard Architecture (ISA), Micro Channel Architecture (MCA), Enhanced ISA (EISA), Video Electronics Standards Association (VESA), and/or Peripheral Component Interconnect (PCI) bus, possibly implemented as a Mezzanine bus manufactured to the IEEE P1386.1 standard).

In some examples, the I/O subsystem 226 may include one or more device controller(s) 228 for one or more user interface input devices and/or user interface output devices, possibly integrated with the computing system 200 (e.g., virtual reality headsets, integrated audio/video systems, and/or touchscreen displays), or may be separate peripheral devices which are attachable/detachable from the computing system 200. Input may include keyboard or mouse input, audio input (e.g., spoken commands), motion sensing, gesture recognition (e.g., eye gestures), etc. As non-limiting examples, input devices may include a keyboard, pointing devices (e.g., mouse, trackball, and associated input), touchpads, touch screens, scroll wheels, click wheels, dials, buttons, switches, keypad, audio input devices, voice command recognition systems, microphones, three dimensional (3D) mice, joysticks, pointing sticks, gamepads, graphic tablets, speakers, digital cameras, digital camcorders, portable media players, webcams, image scanners, fingerprint scanners, barcode readers, 3D scanners, 3D printers, laser rangefinders, eye gaze tracking devices, medical imaging input devices, MIDI keyboards, digital musical instruments, and the like. In general, use of the term “output device” is intended to include all possible types of devices and mechanisms for outputting information from computing system 200, such as to a user (e.g., via a display device) or any other computing system, such as a second computing system 200. In an example, output devices may include one or more display subsystems and/or display devices that visually convey text, graphics and audio/video information (e.g., cathode ray tube (CRT) displays, flat-panel devices, liquid crystal display (LCD) or plasma display devices, projection devices, touch screens, etc.), and/or may include one or more non-visual display subsystems and/or non-visual display devices, such as audio output devices, etc. As non-limiting examples, output devices may include, virtual reality headsets, indicator lights, monitors, printers, speakers, headphones, automotive navigation systems, plotters, voice output devices, modems, etc.

In some examples, the computing system 200 may include one or more storage subsystems 210, including hardware and software components used for storing data and program instructions, such as system memory 218 and computer-readable storage media 216. In some examples, the system memory 218 and/or the computer-readable storage media 216 may store and/or include program instructions that are loadable and executable on the processor(s) 204. In an example, the system memory 218 may load and/or execute an operating system 224, program data 222, server applications, application program(s) 220 (e.g., client applications), Internet browsers, mid-tier applications, etc. In some examples, the system memory 218 may further store data generated during execution of these instructions.

In some examples, the system memory 218 may be stored in volatile memory (e.g., random-access memory (RAM) 212, including static random-access memory (SRAM) or dynamic random-access memory (DRAM)). In an example, the RAM 212 may contain data and/or program modules that are immediately accessible to and/or operated and executed by the processing circuitry 204. In some examples, the system memory 218 may also be stored in non-volatile storage drives 214 (e.g., read-only memory (ROM), flash memory, etc.). In an example, a basic input/output system (BIOS), containing the basic routines that help to transfer information between elements within the computing system 200 (e.g., during start-up), may typically be stored in the non-volatile storage drives 214.

In some examples, the storage subsystem 210 may include one or more tangible computer-readable storage media 216 for storing the basic programming and data constructs that provide the functionality of some embodiments. In an example, the storage subsystem 210 may include software, programs, code modules, instructions, etc., that may be executed by the processing circuitry 204, in order to provide the functionality described herein. In some examples, data generated from the executed software, programs, code, modules, or instructions may be stored within a data storage repository within the storage subsystem 210. In some examples, the storage subsystem 210 may also include a computer-readable storage media reader connected to the computer-readable storage media 216.

In some examples, the computer-readable storage media 216 may contain program code, or portions of program code. Together and, optionally, in combination with the system memory 218, the computer-readable storage media 216 may comprehensively represent remote, local, fixed, and/or removable storage devices plus storage media for temporarily and/or more permanently containing, storing, transmitting, and/or retrieving computer-readable information. In some examples, the computer-readable storage media 216 may include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer-readable media. This can also include nontangible computer-readable media, such as data signals, data transmissions, or any other medium which can be used to transmit the desired information and which can be accessed by the computing system 200. In an illustrative and non-limiting example, the computer-readable storage media 216 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media.

In some examples, the computer-readable storage media 216 may include, but is not limited to, Zip® drives, flash memory cards, universal serial bus (USB) flash drives, secure digital (SD) cards, DVD disks, digital video tape, and the like. In some examples, the computer-readable storage media 216 may include, solid-state drives (SSD) based on non-volatile memory such as flash-memory based SSDs, enterprise flash drives, solid state ROM, and the like, SSDs based on volatile memory such as solid-state RAM, dynamic RAM, static RAM, DRAM-based SSDs, magneto-resistive RAM (MRAM) SSDs, and hybrid SSDs that use a combination of DRAM and flash memory-based SSDs. The disk drives and their associated computer-readable media may provide non-volatile storage of computer-readable instructions, data structures, program modules, and other data for the computing system 200.

In some examples, the communications subsystem 232 may provide a communication interface from the computing system 200 and external computing devices via one or more communication networks, including local area networks (LANs), wide area networks (WANs) (e.g., the Internet), and various wireless telecommunications networks. As illustrated in FIG. 2, the communications subsystem 232 may include, for example, one or more network interface controllers (NICs) 234, such as Ethernet cards, Asynchronous Transfer Mode NICs, Token Ring NICs, and the like, as well as one or more wireless communications interfaces 236, such as wireless network interface controllers (WNICs), wireless network adapters, and the like. Additionally, and/or alternatively, the communications subsystem 232 may include one or more modems (telephone, satellite, cable, ISDN), synchronous or asynchronous digital subscriber line (DSL) units, Fire Wire® interfaces, USB® interfaces, and the like. Communications subsystem 232 also may include radio frequency (RF) transceiver components for accessing wireless voice and/or data networks (e.g., using cellular telephone technology, advanced data network technology, such as 3G, 4G, 5G or EDGE (enhanced data rates for global evolution), Wi-Fi (IEEE 802.11 family standards, or other mobile communication technologies, or any combination thereof), global positioning system (GPS) receiver components, and/or other components.

In some examples, the communications subsystem 232 may also receive input communication in the form of structured and/or unstructured data feeds, event streams, event updates, and the like, on behalf of one or more users who may use or access the computing system 200. In an example, the communications subsystem 232 may be configured to receive data feeds in real-time from users of social networks and/or other communication services, web feeds such as Rich Site Summary (RSS) feeds, and/or real-time updates from one or more third party information sources (e.g., data aggregators). Additionally, the communications subsystem 232 may be configured to receive data in the form of continuous data streams, which may include event streams of real-time events and/or event updates (e.g., sensor data applications, financial tickers, network performance measuring tools, clickstream analysis tools, automobile traffic monitoring, etc.). In some examples, the communications subsystem 232 may output such structured and/or unstructured data feeds, event streams, event updates, and the like to one or more data stores that may be in communication with one or more streaming data source computing systems (e.g., one or more data source computers, etc.) coupled to the computing system 200. The various physical components of the communications subsystem 232 may be detachable components coupled to the computing system 200 via a computer network (e.g., a communication network 120), a FireWire® bus, or the like, and/or may be physically integrated onto a motherboard of the computing system 200. In some examples, the communications subsystem 232 may be implemented in whole or in part by software.

Due to the ever-changing nature of computers and networks, the description of the computing system 200 depicted in the figure is intended only as a specific example. Many other configurations having more or fewer components than the system depicted in the figure are possible. For example, customized hardware might also be used and/or particular elements might be implemented in hardware, firmware, software, or a combination. Further, connection to other computing devices, such as network input/output devices, may be employed. Based on the disclosure and teachings provided herein, a person of ordinary skill in the art will appreciate other ways and/or methods to implement the various embodiments.

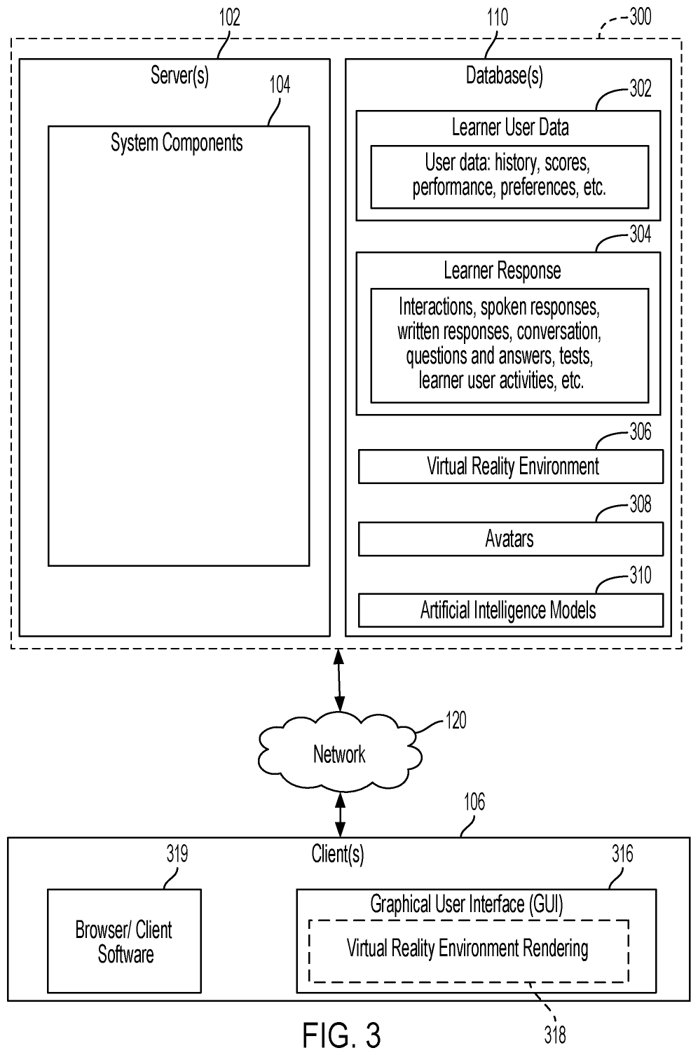

FIG. 3 illustrates a system level block diagram of a virtual reality environment-based language skill development system 300 for providing a language learning and practice environment according to some examples. In some examples, the system 300 may include one or more database(s) 110, also referred to as data stores herein. The database(s) 110 may include a plurality of user data 302 (e.g., a set of user data items). In such examples, the system 300 may store and/or manage the user data 302 in accordance with one or more of the various techniques of the disclosure. In some examples, the user data 302 may include user responses, user history, user scores, user performance, user preferences, and the like.

In some examples, the system 300 may utilize the user data to determine the level of assessments, and in some examples, the language skill development system 300 may customize the level of assessments and/or conversation for a particular user (e.g., a learner user). In some examples, the system 300 may collect and aggregate some or all proficiency estimates and evidence points from various sources (e.g., platforms, learner response assessments, a personalization component, a pronunciation assessment, a practice generation component, etc.) to determine the level of assessments. The level of assessments can be stored in the database 110. In further examples, the level of assessments may be received by other sources (e.g., third-party components).

In addition, the database(s) 110 may include learner response(s) 304. In some examples, the learner response 304 may include multiple communications, interactions, questions, and/or responses of a user with non-player-characters (NPCs) or other users, and an interaction may include a spoken response or a written response. In some examples, the learner response(s) is generated during a conversation, questions and answers, tests, and other various user activities.

In addition, the database(s) 110 may further include a virtual reality environment 306. For example, the system 300 can include the virtual reality environment 306 including multiple learning places, arcades, language Café to practice and develop language skills of the user.

In addition, the database(s) 110 may further include avatars 308. For example, the avatars 308 can exist in the virtual reality environment 306 to interact with each other. In further examples, the avatar 308 can be a conversation partner or a digital tutor to communicate with the user. In some examples, the avatars can be associated with corresponding artificial intelligence models to communicate with, provide feedback to, and/or language assistance to the user.

Further, the database(s) 110 may further include artificial intelligence (AI) models 310. For example, the AI models 310 can correspond to the avatars 308 such that the AI models 310 may be accessed by the server 102 to control the output of the corresponding avatars 308. In other examples, one AI model 310 can correspond to multiple avatars 308. In some examples, the AI models 310 can include generative AI or large language models. In other examples, the AI models 310 can include recurrent neural networks (RNNs), convolutional neural networks (CNNs), transformer models, sequence-to-sequence models, word embeddings, memory networks, graph neural networks or any other suitable artificial intelligence model to process language. In further examples, the artificial intelligence models 310 and/or the avatars 308 can be stored in a remote or cloud server, which is communicatively coupled to the system server 102 over the network 120. In some examples, each AI model can be communicatively coupled to each other and be aware of a conversation with the user using a generative artificial intelligence model.

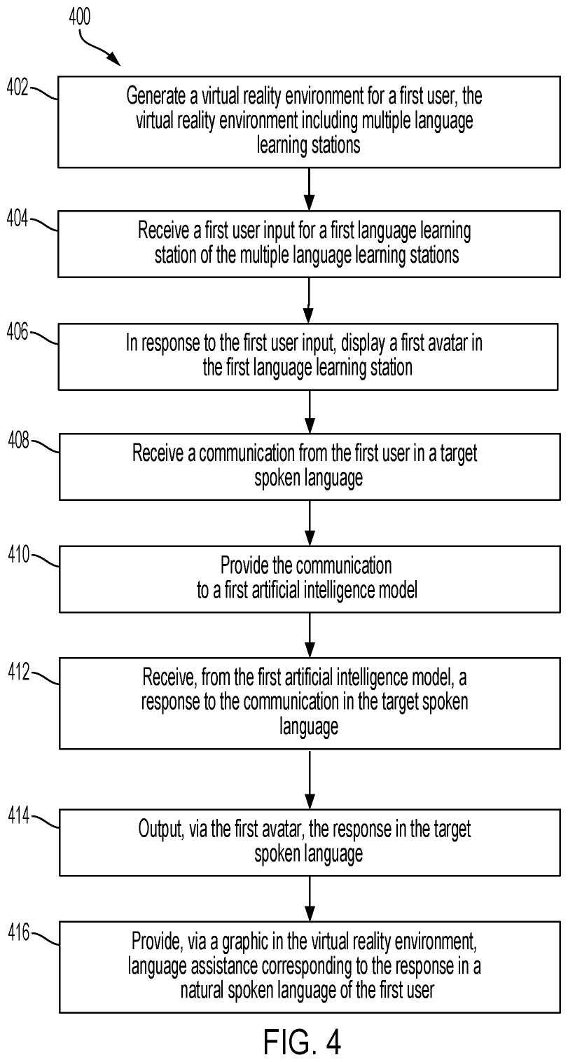

In some aspects of the disclosure, the server 102 in coordination with the database(s) 110 may configure the system components 104 for various functions, including, e.g., displaying a virtual reality environment for a user, receiving a station selection user input to select a language learning station, display a first avatar in the language learning station in response to the station selection user input, receiving a communication from the user in a target spoken language, providing the communication to a first artificial intelligence model, receiving a response to the communication in the target spoken language, outputting, via the first avatar, the response in the target spoken language, providing, via a graphic in the virtual reality environment, language assistance corresponding to the response in a natural spoken language of the user, assigning a characteristic to an avatar using an AI model, displaying one or more conversation topics, receiving a topic selection user input, providing the topic to the AI model, receiving from the AI model a question associated with the first topic, outputting via the avatar the question, providing a written sentence corresponding to the spoken sentence to the user, providing one or more possible responses to the question to the user, providing a translated sentence in a natural language, providing one or more possible responses to the response to the user, providing one or more translated sentences in the natural language corresponding to the one or more possible responses, receiving a second communication from the first user to communicate with the second user, transmitting, via the graphic of the virtual reality environment, the second communication to the second user, receiving, by the electronic processor via the network, a user response from the second user to the user, providing, via the graphic of the virtual reality environment, the user response to the user, providing one or more conversation topics, receiving a topic selection user input to select a first topic of the one or more conversation topics, providing one or more possible questions being associated with the first topic, converting, by the electronic processor, the spoken sentence to a written sentence, providing the written sentence to the first user, providing one or more possible responses to the user response to the first user, displaying a first translated sentence in a natural language corresponding to the written sentence, displaying a second translated sentence in the natural language corresponding to the one or more possible responses, receiving a second station selection user input for a language learning station, in response to the second station selection user input, providing a language learning lesson, transferring control to an external language learning system, and/or operating a language game for the user. For example, the system components 104 may be configured to implement one or more of the functions described below in relation to FIG. 4, including, e.g., blocks 402-416. The system components 104 may, in some examples, be implemented by an electronic processor of the server 102 (e.g., processing circuitry 204 of FIG. 2) executing instructions stored and retrieved from a memory of the server 102 (e.g., storage subsystem 210, computer readable storage media 216, and/or system memory 218 of FIG. 2). Accordingly, as used herein, a processor (or electronic processor), such as may execute one or more of the functions of FIG. 4, may refer to one or more processors (or electronic processors), as well as other configurations as described with respect to the processing circuitry 204 of FIG. 2.

In some examples, the system 300 may interact with the client computing device(s) 106 via one or more communication network(s) 120. In some examples, the client computing device(s) 106 can include a graphical user interface (GUI) 316 to provide a virtual reality environment 318, one or more language stations, and/or one or more avatars to speak with for the user. In some examples, the GUI 316 may be generated in part by execution by the client 106 of browser/client software 319 and based on data received from the system 300 via the network 120.

FIG. 4 illustrates a process 400 for bidirectional communication in a virtual reality environment, in accordance with various aspects of the techniques described in this disclosure. The flowchart of FIG. 4 utilizes various system components that are described below with reference to FIGS. 1-3 and 5-10. In some examples, the process 400 may be carried out by the server(s) 102 illustrated in FIG. 3, e.g., employing circuitry and/or software configured according to the block diagram illustrated in FIG. 2. In some examples, the process 400 may be carried out by any suitable apparatus or means for carrying out the functions or algorithm described below. Additionally, although the blocks of the process 400 are presented in a sequential manner, in some examples, one or more of the blocks may be performed in a different order than presented, in parallel with another block, or bypassed.

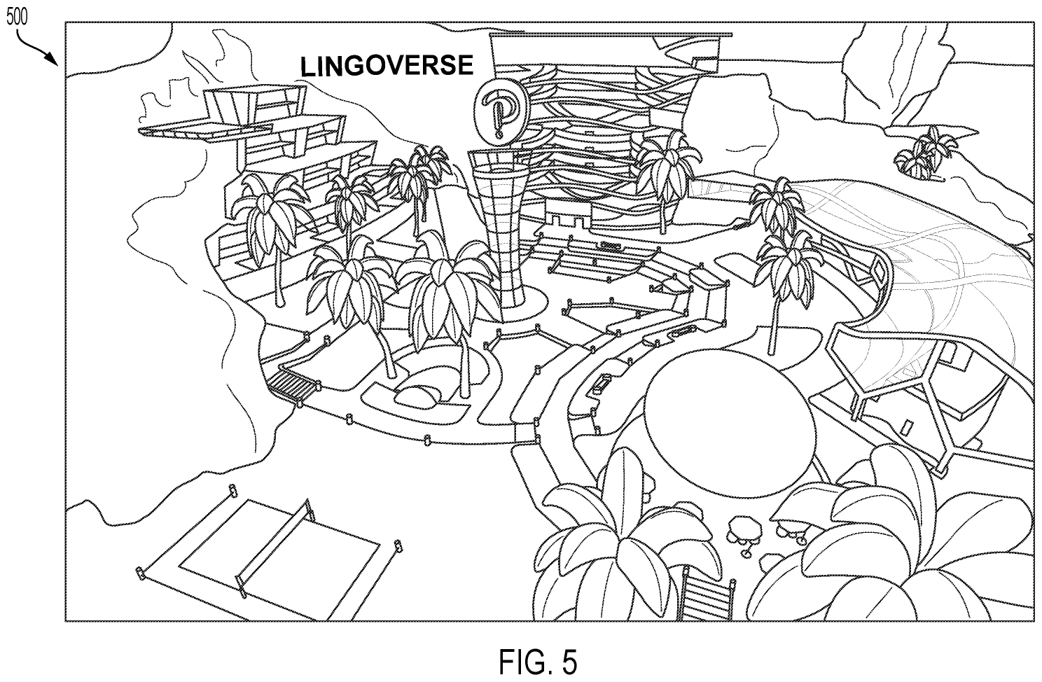

At block 402, a server (e.g., one or more of the server(s) 102, also referred to as the server 102) generates a virtual reality environment for the first user. For example, the server 102 may transmit digital information defining the virtual reality environment (e.g., instructions, data, and the like) to cause the virtual reality environment to be displayed on a graphical user interface (GUI) of a client device 106 for the first user. The virtual reality environment can include a graphic of a computer-generated environment (e.g., a two-dimensional or three-dimensional simulated environment) where the first user can explore and interact with scenes and objects in the environment using a display of the client device 106. As a large open virtual reality world, the virtual reality environment can have a multiplayer functionality such that multiple users can interact with scenes, objects, and other users in the environment at the same time. FIG. 5 shows an example virtual reality environment 500. In some examples, the virtual reality environment 500 can include multiple language learning stations. For example, a language learning station can be a specific place (e.g., a café, a basketball court, a soccer field, a classroom, a theme park, a hotel, a gym, an airport, a subway, a building, a grocery store, a restaurant, a gas station, a beach, a swimming pool, etc.) in the virtual reality environment 500, a general place (e.g., lobby, hallway, garden, etc.) in the virtual reality environment 500, another avatar as a conversation partner in the virtual reality environment 500, and/or an external language learning place, which can be accessed through an indication (e.g., a door, an entrance, etc.) in the virtual reality environment 500. In some examples, the first user can include one or more users and explore language learning stations with one or more corresponding avatars in the virtual reality environment 500.

In some examples, the server 102 can provide an avatar for the first user via the graphic in the virtual reality environment 500. In some examples, an avatar provided via a graphic in the virtual reality environment 500 can include a digital human (or digital person, metahuman, humanoid, etc.), a digital character, and/or a non-player-character (NPC). In some examples, a digital character as an avatar can be a human-like digital avatar that has less visual fidelity than the digital human. The digital character can use simpler animations (e.g., cartoon characters) that loop through a few poses and expressions, unlike the digital human that generates finer emotional states and movements through the use of artificial intelligence models and more sophisticated muscle control. In some examples, the server 102 can use the digital character as the avatar in the virtual reality environment 500 to reduce network traffic for the avatar on the client device over the network. In such examples, the reduced resolution of the avatar uses less pixel information to demonstrate facial or body features and can show smooth movement of the avatar in the virtual reality without any delay. An NPC is a character that performs a role of different human-like characters but that are not controlled by a user. In some examples, NPCs are characters located inside the virtual reality environment and are connected to one or more generative artificial intelligence models. The NPCs may have different personalities and storylines, designed to provide interesting conversational practice to language learners who can interact with NPCs or with other users in the virtual reality environment 500. Here, the avatar for the first user can be a digital human or a digital character. In some examples, another avatar, which is not controlled by a user, can be an NPC, which can be a digital human or a digital character.

In some examples, the server 102 can generate, via the graphic in the virtual reality environment 500, an avatar for the first user. The first user can explore the virtual reality environment 500 by controlling the avatar in the virtual reality environment 500. The user can provide a user input (e.g., arrow keys of a keyboard, a movement of a mouse, a movement of a joystick, a movement of a wearable device, etc.) using the client device 106 over the communication network 120 to move the avatar for the first user in the virtual reality environment 500. In some examples, the server 102 can display the avatar or the part of the avatar such that the first user is able to see the avatar on the screen of the client device 106 for the first user. In other examples, the server 102 may not display the avatar on the screen of the client device 106 for the first user while other users in the virtual reality environment 500 can see the avatar for the first user.

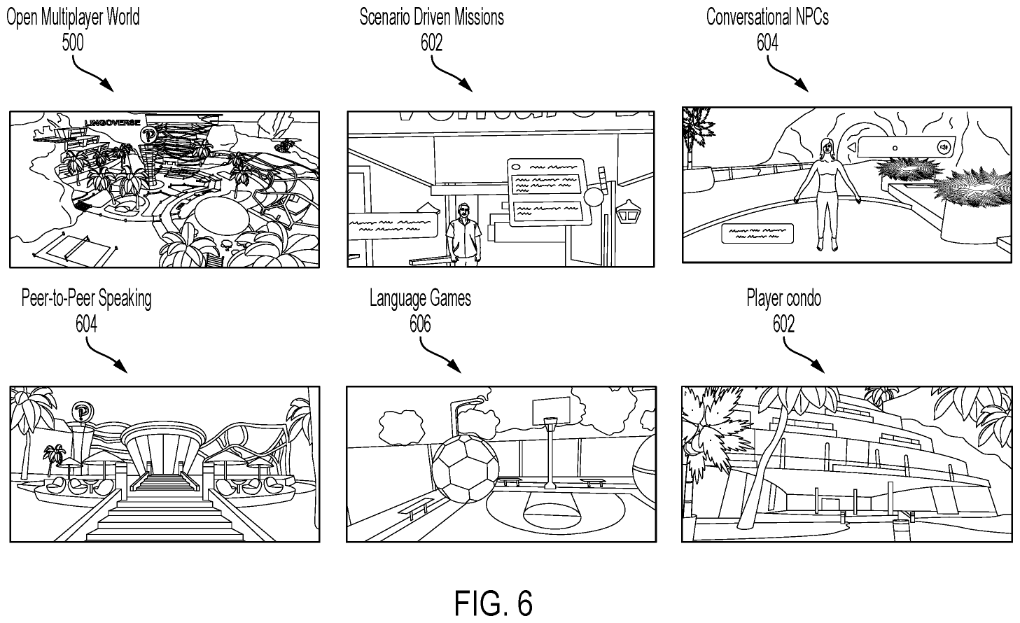

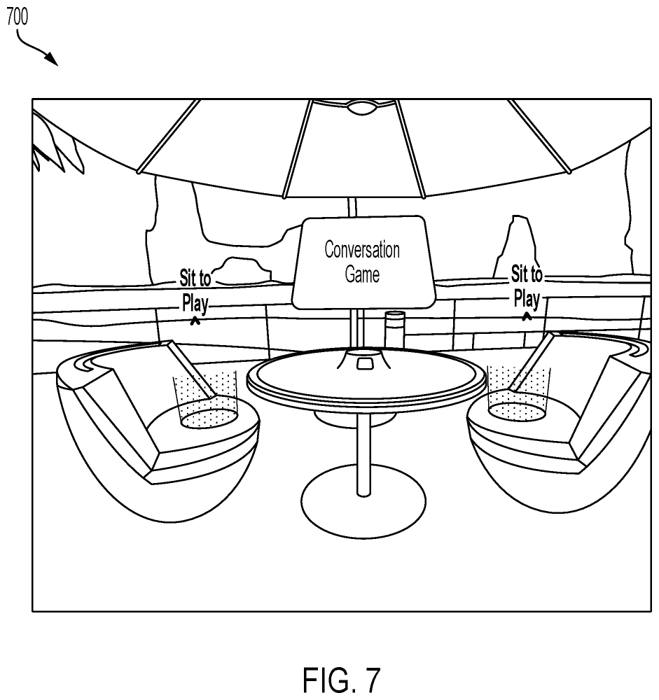

At block 404, the server 102 receives a station selection user input to select a first language learning station of the multiple language learning stations. In some examples, the first user via the client device 106 can provide the station selection user input to select the first language learning station to the server 102 over the communication network 120. The station selection user input can be provided as text and/or keys entered via a keyboard, provided as an audio signal captured via a microphone, provided as an indication of selection generated via a graphical user interface (e.g., via drop down menu, virtual scroll wheel, soft button selection, etc.) using a touch screen, mouse, joystick, or other input device. For example, the first user via the client device 106 can provide the station selection user input to select the first language learning station by moving the first user's avatar in the virtual reality environment to the first language learning station. In some examples shown in FIG. 6, the first user can select a language learning station by moving the first user's avatar to a specific location 602 (e.g., a language café, a restaurant, a hotel, etc.) or opening a door of the specific location 604 to learn and practice language in the specific location. In further examples, the first user can select a language learning station by moving the first user's avatar to another avatar (e.g., a conversational NPC or another user) or selecting (e.g., clicking via a mouse or a joystick) another avatar to practice language with other NPC or user. In even further examples, the first user can select a language learning station by moving the first user's avatar to a game place 606 to play a language game. In further examples shown in FIG. 7, the first user can select a language learning station by moving the first user's avatar to a language café to practice discussing certain topics with a conversational NPC or another user in the virtual reality environment.

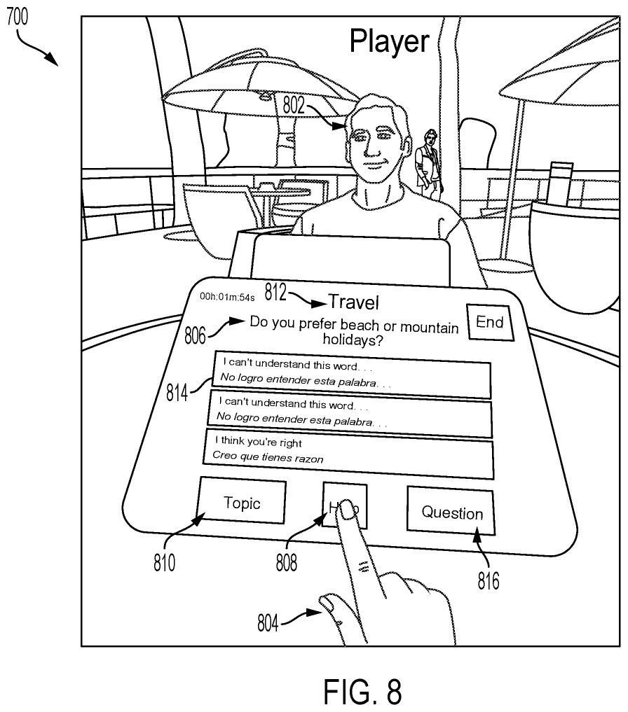

At block 406, the server 102 provides, via a graphic in the virtual reality environment, a first avatar in the first language learning station in response to the station selection user input. FIG. 8 illustrates a language learning station (e.g., the language café 700) with the first avatar 802 for an NPC or other user to practice language with the first avatar. In such examples, when the first user selects the language café 700 (i.e., the first language learning station) by moving the first user's avatar 804 to the language café 700, the server 102 can display or provide the first avatar 802 in the language café 700. In some examples, the first user can invite an NPC or another user for the first avatar 802 in the language café 700. In other examples, the server 102 can provide multiple avatars in a language learning station of the virtual reality environment 500. For example, the server 102 can provide, via the graphic in the virtual reality environment a second avatar for a second user or an NPC.

In further examples, the server 102 can provide a language learning lesson in response to the station selection user input. For example, the first user can move to a language learning station or open a door of the language learning station, which acts as a portal to virtual reality daily lessons or classes. In some examples of the language learning lesson, a teacher avatar in the language learning station (e.g., a classroom or any suitable place to provide the language learning lesson) can provide prerecorded or preprogramed language learning instructions. In further examples, the server 102 can provide the teacher avatar, which provides language learning instructions and interacts with the first user by providing questions to the first user and answering questions from the first user.

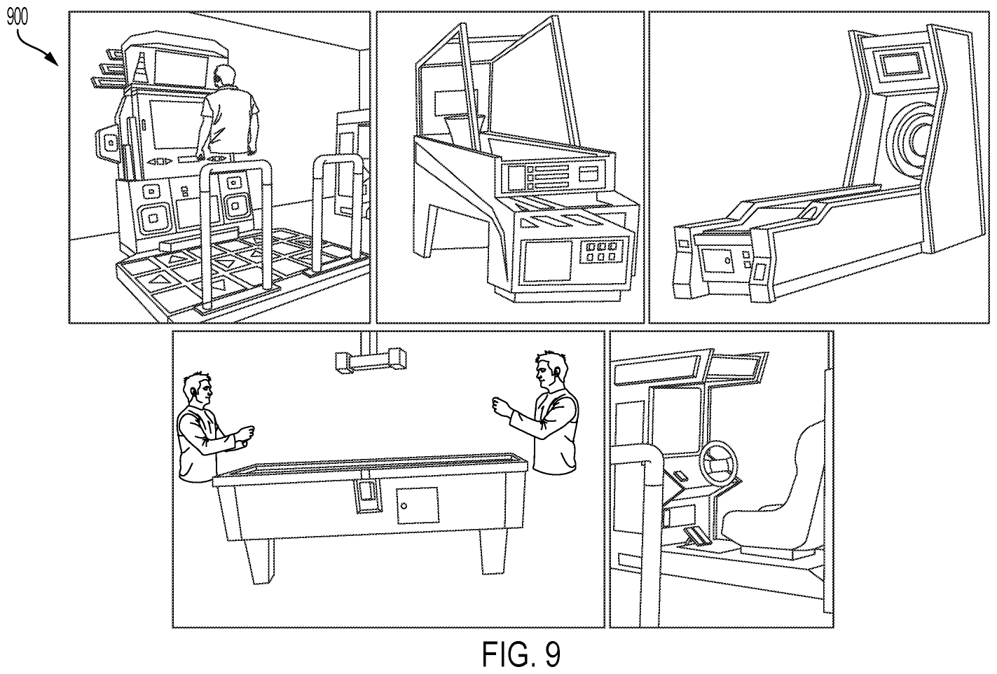

In further examples, the server 102 can operate a language game in response to the station selection user input. For example, when the server 102 receives the user input to select the language game, the server 102 can run the language game in the virtual reality environment. In some examples, the server 102 can provide extensive learning lessons, includes arcades with virtual reality games 900 for language learning as shown in FIG. 9. In further examples, the server 102 can provide other virtual reality games (e.g., soccer, basketball, etc.) for language learning. The language game is designed to language learning while the first user plays the game.

In further examples, the server 102 can access an external language learning system in response to the station selection user input. In some examples, the external language learning system can include a logically or physically separate system from the virtual reality environment 500, or a third-party language learning system. The external language learning system can be stored in the same one or more data stores 110 as the virtual reality environment or in a different data store from the virtual reality environment, which is communicationally coupled to the external language learning system over the communication network 120. In some examples, when the first user can move to a language learning station or open a door of the language learning station for the external language learning system, the server 102 can automatically and seamlessly connects to the external language learning system. In such examples, the server 102 can await the exit of the first user from the external language learning system and place the first user to the last location in the virtual reality environment 500 before the first user accesses the external language learning system. Thus, the first user does not recognize that the external language learning system is a separate system from the virtual reality environment 500 or is not part of the virtual reality environment 500.

At block 408, the server 102 receives a communication from the first user in a target spoken language. For example, the first user can use a microphone, a keyboard, or any other suitable device to produce a communication in the client device 106 to communicate with the first avatar in the virtual reality environment 500. Then, the server 102 can receive the communication from the client device 106 over the communication network 120. In some examples, the communication can include one or more spoken sentences, one or more spoken words, one or more written sentences, or one or more written words. When the communication is a spoken communication (e.g., one or more spoken sentences, one or more spoken words), the server 102 can transcribe the spoken communication into a written communication to be processed in a first artificial intelligence (AI) model. In some examples, to transcribe the spoken communication, the server 102 can utilize the same AI model or a different AI model to recognize the spoken communication and convert the spoken communication to the written communication. In some examples, the first user can select the target spoken language to practice and a natural spoken language in which the first user is fluent (also referred to as a native language of the user). Based on the target spoken language and the natural spoken language, the server 102 can prepare avatars associated with AI models, which are trained in the target spoken language and/or the natural spoken language.

In some examples, the server 102 can receive other communications from the first user to communicate with another user using another avatar. For example, the server 102 can receive a second communication from the first user to communicate with the second user (e.g., communicatively coupled to the virtual reality environment 500 displayed on the client device 106 for the second user). In such examples, the server 102 can provide the second communication to the second user. Then, the server 102 can receive a user response from the second user to the first user and provide, via the second avatar in the virtual reality environment, the user response to the first user. In some examples, the server 102 can correct or revise the second communication to be grammatically accurate and provide the revised second communication to the second user. Similarly, the server 102 can correct or revise the user response from the second user to be grammatically accurate and provide the revised user response to the first user.

At block 410, the server 102 provides the communication to a first AI model. In some examples, the first AI model can be associated with the first avatar. In such examples, the first avatar can be powered by the first AI model to communicate with the first user. The first AI model can include a generative AI or a large language model. In other examples, the AI model can include a recurrent neural network (RNN), a convolutional neural network (CNN), a transformer model, a sequence-to-sequence model, a word embedding, a memory network, a graph neural network or any other suitable artificial intelligence model to process language. In further examples, the first AI model can be trained to process the communication in the target spoken language. In further examples, the first AI model can be trained to process various languages including the target spoken language and other languages (e.g., a natural spoken language of the first user).

In some examples, the server 102 can assign multiple AI models to multiple avatars to correspond the multiple avatars to the multiple AI models. In some examples, each NPC for an avatar can use a different AI model of to process the communication. For example, the server 102 can train or configure AI models with different characteristics, such as, for example, an accent, a voice tone, an age, a speaking style, a job, an education level based on a job, or any other suitable characteristics of the corresponding avatars, which are associated with the AI models. For example, when an avatar associated with an AI model is a college student from Texas, the avatar, via the AI model trained with the characteristics, speaks like a college student with the southern American accent. On the other hand, when an avatar associated with an AI model is a businessperson from Chicago, the avatar, via the AI model trained with the characteristics, speaks like a businessperson with the midwestern American accent.

In some examples, one or more of the AI models may be provided by the same overall large language model, or different instances of the same overall large language model, but these AI model(s) are configured (e.g., with one or more initializing prompts) to serve as different AI models (e.g., one for each NPC avatar). For example, before or at the time of requesting that an AI model generate an output, the server 102 may configure a large language AI model with an initializing prompt to define the AI model as being a college student from Texas or as being a businessperson from Chicago, Illinois. As an example, the server 102 may transmit a request to a large language model to generate a question for a barista (avatar) to ask a customer that just entered the barista's (virtual) coffee shop, where the barista (avatar) is a 25-year-old male and coffee shop is based in Chicago. The request may include additional characteristics for the avatar and/or location. In another example, the server 102 may transmit a request to the large language model to generate a question for a travel agent (avatar) to ask a customer that just entered the agent's (virtual) travel business, where the travel agent (avatar) is a 40-year-old female and travel business is based in Houston, Texas. Here, the large language model (or two instances of the large language model) is/are serving as the respective AI models for the two avatars based on the configuration information that the model(s) receive (e.g., from the server 102).

In some examples, the server 102 can assign one or different characteristics to one or more avatars to output the response based on the assigned characteristics. For example, a first characteristic to the first avatar using the first artificial intelligence (AI) model. In some examples, the response is generated from the first artificial intelligence model based on the first characteristic, which is assigned to the first avatar. The first characteristic can be associated with the first language learning station. In further examples, the server 102 can assign a second characteristic for a second avatar using a second avatar using a second AI model (which is described in connection with block 410). The second characteristic of the second avatar can be the same or different from the first characteristic of the first avatar. Then, the server 102 can provide, via the graphic in the virtual reality environment, the second avatar in the first language learning station. The server 102 can provide, via the graphic in the virtual reality environment, a second communication from the second avatar to the first user based on the second characteristics.

In further examples, the server 102 can provide user information of the first user to the first AI model. For example, the server 102 may provide, to the first AI model, user information about the first user (e.g., age, gender, name, location, target spoken language, natural spoken language, current language skill level of the target spoken language, target language skill level of the target language, etc.). In some examples, the first AI models can obtain this user information, or a portion thereof, in real time at the time of the conversation beginning with the first user. In other examples, the first AI model can obtain this user information, or a portion thereof, in advance of the conversation or from a prior conversation (e.g., from a data store 110, system memory 218, or another memory).

At block 412, the server 102 receives, from the first AI model, a response to the communication in the target spoken language. In some examples, the response can include one or more spoken sentences, or one or more spoken words, one or more written sentences, or one or more written words, which is associated with the communication received from the first user. In some examples, the response can be generated from the first AI model based on the characteristics (e.g., an accent, a voice tone, an age, a speaking style, a job, an education level based on a job, or any other suitable characteristics) of the first avatar. In further examples, the response can be generated from the first AI model based on the user information of the first user (which may be communicated to the first AI model, e.g., in block 410). For example, when the current language skill of the target spoken language for the first user is equivalent to a middle school student, the first AI model can generate the response using vocabularies and grammars that a middle school student uses. In further examples, when the target language skill of the target spoken language for the first user is set as an advanced level of business target language, the first AI model generates the response using vocabularies and grammars that a businessperson uses. In other examples, the first AI model associated with the first avatar can be trained with a different language from the target spoken language. In such examples, the first AI model can produce the response indicating that the first avatar cannot understand the communication in the target speaking language.

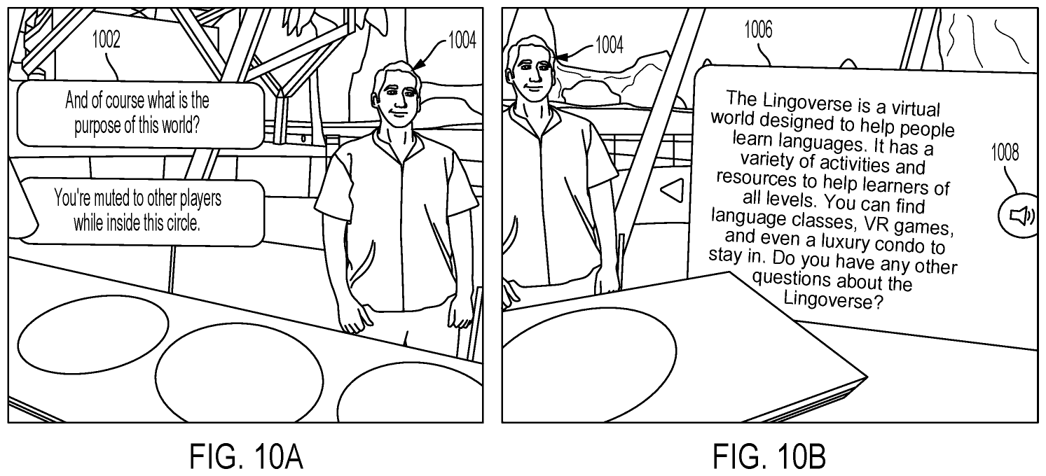

At block 414, the server 102 outputs, via the first avatar, the response in the target spoken language. For example, the first avatar can be associated with the first AI model, which produces the response to the communication from the first user. In such examples, the server 102 can use the first avatar to produce the response. Thus, the first user recognizes that the first avatar speaks or provides the response without being aware of the first AI model. In some examples, the first AI model can produce the response with one or more written statements or words. In such examples, the server 102 can convert the response to one or more spoken statements or words (e.g., using the same or different AI model). Then, the server 102 can control the first avatar to move the lips and pose gestures associated with the response to be displayed on the client device 106 and transmit the one or more spoken statements or words to the client device 106 for the first use to produce sound of the one or more spoken statements or words using a speaker of the client device 106. In some examples, the server 102 outputs the response in the target spoken language with a spoken response and/or a written response. Referring to FIGS. 10A-10B, the server 102 can transcribe the communication 1002 from the user. Thus, the user can see the communication that the server 102 received from the user. Further, the server 102 can produce, via an avatar 1004, the response 1006 (e.g., spoken statements, spoken words, written statements, and/or written words) in response to the communication 1002. In addition, the server 102 can provide an indication 1008 to repeat to speak the response 1006 from the avatar 1004.

At block 416, the server 102 provides, via the graphic in the virtual reality environment, language assistance corresponding to the response in a natural spoken language of the first user. For example, to provide the language assistance, the server 102 can provide a first translated sentence in the natural spoken language (e.g., using the first AI model or any other suitable AI model) where the first translated sentence corresponds to the response. The server 102 can also provide one or more possible responses to the response to the first user and one or more second translated sentences, which correspond to the one or more possible responses. Referring again to FIG. 8, the server 102 can provide the response or a question 806 from the first avatar in a spoken communication (e.g., one or more spoken sentences or one or more spoken words). To provide the language assistance, the server 102 can provide the response or the question 806 in a written response along with the spoken communication. In other example, the server 102 can provide the written response or question 806 when the first user requests (e.g., selecting an assistance request indication 808) the written response.

In further examples, the server 102 can other language assistance. In some examples, the server 102 can provide the language assistance by suggesting a conversation topic. For example, the server 102 can provide one or more conversation topics. Then, the server 102 can receive a topic selection user input to select a first topic of the one or more conversation topics. In further examples, the server 102 can provide the language assistance by providing possible responses that the user can provide in response to a communication from the server 102. In some examples, the server 102 can provide the first topic to the first AI model, receive, from the first AI model, a question associated with the first topic, and output, via the first avatar, the question for the user. In such examples, the question can include a spoken sentence. Then, the server 102 can provide a written sentence corresponding to the spoken sentence to the first user and one or more possible responses to the question to the first user. Referring again to FIG. 8, the server can display a topic indication 810. When the first user selects the topic indication 810, the server 102 provide a list of topics to speak with the first avatar 802. For example, the first user selects “travel” 812 as a topic to communicate with the first avatar 802, the server 102 can provide the topic to the first AI model and generate, via the first avatar 802, a question 806 associated with the topic. In addition, the server 102 can provide, via the first AI model, one or more possible responses 814 to the first user. Further, the server 102 can provide the one or more possible responses 814 as translated responses that are in the natural spoken language in a spoken communication or a written communication. In other examples, the server 102 can provide a question indication 816 to provide a list of questions associated with the topic.

In further examples, when the server 102 receives the user response from the second user, the user response can include a spoken sentence. In such examples, the server can convert the spoken sentence to a written sentence, provide the written sentence to the first user. In further examples, the server can provide one or more possible responses to the user response to the first user. The written sentence can be in the target spoken language. Then, the server can provide a first translated sentence in a natural language corresponding to the written sentence in the target spoken language and provide second one or more translated sentences in the natural spoken language corresponding to the one or more possible responses.

Other examples and uses of the disclosed technology will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

What is claimed:

1. A method for bidirectional communication in a virtual reality environment, comprising:
generating, by an electronic processor, the virtual reality environment for a first user, the virtual reality environment comprising a plurality of language learning stations;
receiving, by the electronic processor via a network, a station selection user input to select a first language learning station of the plurality of language learning stations;
in response to the station selection user input, providing, via a graphic in the virtual reality environment, a first avatar in the first language learning station;
receiving, by the electronic processor via the network, a communication from the first user in a target spoken language;
providing, by the electronic processor, the communication to a first artificial intelligence model;
receiving, from the first artificial intelligence model, a response to the communication in the target spoken language;
outputting, via the first avatar, the response in the target spoken language; and
providing, via the graphic in the virtual reality environment, language assistance corresponding to the response in a natural spoken language of the first user.

2. The method of claim 1, further comprising:
assigning, by the electronic processor, a first characteristic to the first avatar using the first artificial intelligence model, the first characteristic being associated with the first language learning station, and
wherein the response is generated from the first artificial intelligence model based on the first characteristic.

3. The method of claim 2, further comprising:
assigning, by the electronic processor, a second characteristic for a second avatar using a second artificial intelligence model, the second characteristic being different from the first characteristic;
providing, via the graphic in the virtual reality environment, the second avatar in the first language learning station; and
providing, via the graphic in the virtual reality environment, a second communication from the second avatar to the first user based on the second characteristic.

4. The method of claim 1, further comprising:
providing, by the electronic processor, one or more conversation topics;
receiving, by the electronic processor via the network, a topic selection user input to select a first topic of the one or more conversation topics;
providing the first topic to the first artificial intelligence model;
receiving, from the first artificial intelligence model, a question associated with the first topic; and
outputting, via the first avatar, the question.

5. The method of claim 4, wherein the question comprises a spoken sentence,
wherein the method further comprises:
providing, by the electronic processor, a written sentence corresponding to the spoken sentence to the first user; and
providing, by the electronic processor, one or more possible responses to the question to the first user.

6. The method of claim 1,
wherein the providing of the language assistance comprises:
providing, by the electronic processor, a first translated sentence in the natural spoken language, the first translated sentence corresponding to the response; and
providing, by the electronic processor, one or more possible responses to the response to the first user; and
providing, by the electronic processor, one or more second translated sentences in the natural spoken language corresponding to the one or more possible responses.

7. The method of claim 1, further comprising:
providing, via the graphic in the virtual reality environment, a second avatar for a second user;
receiving, by the electronic processor via the network, a second communication from the first user to communicate with the second user;
providing the second communication to the second user; and
receiving, by the electronic processor via the network, a user response from the second user to the first user; and
providing, via the second avatar in the virtual reality environment, the user response to the first user.

8. The method of claim 7, wherein the user response comprises a spoken sentence,
wherein the method further comprises:
converting, by the electronic processor, the spoken sentence to a written sentence;
providing, by the electronic processor, the written sentence to the first user; and
providing, by the electronic processor, one or more possible responses to the user response to the first user.

9. The method of claim 8, wherein the written sentence is in the target spoken language,
wherein the method further comprises:
providing, by the electronic processor, a first translated sentence in a natural spoken language corresponding to the written sentence; and
providing, by the electronic processor, one or more second translated sentences in the natural spoken language corresponding to the one or more possible responses.

10. The method of claim 1, further comprising:
receiving, by the electronic processor via the network, a second station selection user input for a second language learning station of the plurality of language learning stations; and
in response to the second station selection user input, providing, by the electronic processor, a language learning lesson in the second language learning station.

11. The method of claim 1, further comprising:
receiving, by the electronic processor via the network, a second station selection user input for a second language learning station of the plurality of language learning stations; and
in response to the second station selection user input, accessing, by the electronic processor, an external language learning system.

12. The method of claim 1, further comprising:
receiving, by the electronic processor via the network, a second station selection user input for a second language learning station of the plurality of language learning stations; and
in response to the second station selection user input, operating, by the electronic processor, a language game.

13. A system for bidirectional communication in a virtual reality environment, comprising:
a memory; and
an electronic processor coupled with the memory,
wherein the electronic processor is configured to:
generate the virtual reality environment for a first user, the virtual reality environment comprising a plurality of language learning stations;
receive a station selection user input to select a first language learning station of the plurality of language learning stations;
in response to the station selection user input, provide, via a graphic in the virtual reality environment, a first avatar in the first language learning station;
receive a communication from the first user in a target spoken language;
provide the communication to a first artificial intelligence model;
receive, from the first artificial intelligence model, a response to the communication in the target spoken language;
output, via the first avatar, the response in the target spoken language; and
provide, via the graphic in the virtual reality environment, language assistance corresponding to the response in a natural spoken language of the first user.

14. The system of claim 13, wherein the electronic processor is further configured to:
assign a first characteristic to the first avatar using the first artificial intelligence model, the first characteristic being associated with the first language learning station, and
wherein the response is generated from the first artificial intelligence model based on the first characteristic.

15. The system of claim 14, wherein the electronic processor is further configured to:
assign a second characteristic for a second avatar using a second artificial intelligence model, the second characteristic being different from the first characteristic;
provide, via the graphic in the virtual reality environment, the second avatar in the first language learning station; and
provide, via the graphic in the virtual reality environment, a second communication from the second avatar to the first user based on the second characteristic.

16. The system of claim 13, wherein the electronic processor is further configured to:
provide one or more conversation topics;
receive a topic selection user input to select a first topic of the one or more conversation topics;
provide the first topic to the first artificial intelligence model;
receive, from the first artificial intelligence model, a question associated with the first topic; and
output, via the first avatar, the question.

17. The system of claim 16, wherein the question comprises a spoken sentence,
wherein the electronic processor is further configured to:
provide a written sentence corresponding to the spoken sentence to the first user; and
provide one or more possible responses to the question to the first user.

18. The system of claim 13, wherein to provide the language assistance, the electronic processor is configured to:
provide a first translated sentence in the natural spoken language, the first translated sentence corresponding to the response; and
provide one or more possible responses to the response to the first user; and
provide one or more second translated sentences in the natural spoken language corresponding to the one or more possible responses.

19. The system of claim 13, wherein the electronic processor is further configured to:
provide, via the graphic in the virtual reality environment, a second avatar for a second user;
receive a second communication from the first user to communicate with the second user;
provide the second communication to the second user; and
receive a user response from the second user to the first user; and
provide, via the second avatar in the virtual reality environment, the user response to the first user.

20. The system of claim 19, wherein the user response comprises a spoken sentence,
wherein the electronic processor is further configured to:
convert the spoken sentence to a written sentence;
provide the written sentence to the first user; and
provide one or more possible responses to the user response to the first user.

21. The system of claim 20, wherein the written sentence is in the target spoken language,
wherein the electronic processor is further configured to:
provide a first translated sentence in a natural spoken language corresponding to the written sentence; and
provide one or more second translated sentences in the natural spoken language corresponding to the one or more possible responses.

22. The system of claim 13, wherein the electronic processor is further configured to:
receive a second station selection user input for a second language learning station of the plurality of language learning stations; and
in response to the second station selection user input, provide a language learning lesson in the second language learning station.

23. The system of claim 13, wherein the electronic processor is further configured to:
receive, via a network, a second station selection user input for a second language learning station of the plurality of language learning stations; and
in response to the second station selection user input, access an external language learning system.

24. The system of claim 13, further comprising:
receive a second station selection user input for a second language learning station of the plurality of language learning stations; and
in response to the second station selection user input, operate a language game.
